(19) United States
(12) Patent Application Publication
(10) Pub. No.: US 2008/0302923 A1
(43) Pub. Date: Dec. 11, 2008

(54) PAN ASSEMBLY FOR SUPPORTING CONCRETE SUPPLY HOSE

(75) Inventors: Timothy E. Ruonavaara, Calumet, MI (US); Jeffrey W. Torvinen, South Range, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: SOMERO ENTERPRISES, INC., Jaffrey, NH (US)

(21) Appl. No.: 12/136,489

(22) Filed: Jun. 10, 2008

Related U.S. Application Data
(60) Provisional application No. 60/943,167, filed on Jun. 11, 2007.

(51) Int. Cl. F16M 11/22

(52) U.S. Cl. 248/76

(57) ABSTRACT

A pan assembly for supporting a concrete supply hose at a support surface includes a pan body having a generally flattened or generally planar lower surface and a generally vertical sidewall with a curved transition between the lower surface and the sidewall. The pan assembly includes at least one support member extending upwardly from a generally central region of the pan body and radially inward of the sidewall. The at least one support member is configured to at least partially receive a hose section at an upper end thereof. The sidewalls may include hose receiving recesses to at least partially receive the hose therein, such that the pan assembly provides a low profile support of the concrete supply hose.

### CROSS REFERENCE TO RELATED APPLICATION

The present application claims the benefit of U.S. provisional application Ser. No. 60/943,167, filed Jun. 11, 2007, which is hereby incorporated herein by reference in its entirety.

### FIELD OF THE INVENTION

The present invention relates generally to concrete placing devices and, more particularly, to devices for placing concrete via one or more concrete supply hoses that provide a conduit for directing uncured concrete to a targeted location.

### BACKGROUND OF THE INVENTION

Typically, uncured concrete may be conveyed or conduited from a source or supply, such as a truck or the like, to a targeted placing location, where the uncured concrete is discharged onto the targeted area via a discharge device or nozzle. The uncured concrete is often pumped into a flexible concrete supply hose that may be laid along the ground or subgrade surface between the concrete supply or source and the discharge device. As the discharge device is moved over the targeted area, the supply hose must also be moved to accommodate the movement of the discharge device relative to the concrete source. The combination of jointed lengths of thick-walled rubber hose of about 4 to 6 inches (10 to 15 cm) in diameter filled with uncured mixed concrete under high pressure presents itself as a heavy and bulky object to physically move. As the heavy rubber supply hose or hoses are moved or otherwise dragged or slid over the ground or the concrete subgrade, which may often include for example, steel decking, wire mesh, steel rebar and/or the like, excessive wear of the hoses and couplings may occur as a result of heavy contact and friction as the hose encounters rough or uneven terrain or the concrete steel reinforcement materials.

Conventional steel pans are currently used to support the heavy concrete hose and tend to be generally round and spherical at the bottom, while at the same time, the hose is supported at a relatively high position with respect to the bottom friction surface of the pan. The current combination of a generally rounded or spherical bottom shape of the pan, high friction with the support surface, and the relatively high position of the supported hose, tends to contribute or cause the conventional steel pans to readily stick and then easily tip over whenever the hose is being moved or dragged. When the pans tend to easily tip, it is also very easy for the unsecured concrete supply hose and couplings to become detached or completely disengaged from the pan. Constantly having to watch for and correct such problems can cause a great deal of extra effort and work for the concrete construction work crews using such equipment.

Therefore, there is a need in the art for a device and/or method that better protects the concrete supply hose or sections of hose and couplings from excessive wear and thus overcomes the shortcomings of the prior art.

### SUMMARY OF THE INVENTION

The present invention provides a pan assembly for attaching to and supporting a concrete supply hose as the hose is moved over a support surface or floor or ground, such as during a concrete placing operation. The hose support pan assembly of the present invention provides support of the hose at a plurality of locations across the hose support pan body and provides a generally flat or flattened or generally planar supporting surface at the ground to provide enhanced or substantially smooth movement of the supply hose across uneven terrain or surfaces, such as rebar supports and the like.

According to an aspect of the present invention, a pan assembly for supporting a concrete supply hose at a support surface includes a pan body having a generally flattened or generally planar lower surface and a generally vertical sidewall with a curved transition between the lower surface and the sidewall. The pan assembly includes at least one support member extending upwardly from a generally central region of the pan body and radially inward of the sidewall. The at least one support member is configured to at least partially receive a hose section at an upper end thereof.

The at least one support member may comprise a pair of spaced apart support members, with each of the support members having a receiving axis generally aligned with one another so as to at least partially receive a hose section at upper ends thereof with the hose section being substantially straight between the support members. The sidewall of the pan body may include hose receiving recesses established at opposite portions thereof, and the hose support axes of the support members are preferably co-axially aligned with support axes of the hose receiving recesses.

Optionally, the support members are configured to at least partially receive a hose section at a coupling of a hose section. A securing element may be provided that is connectable to the sidewall at opposite portions thereof, and that overlays and engages the concrete supply hose at or near the support member or members to limit movement of the concrete supply hose relative to the support member or members.

Therefore, the support pans of the present invention provide a device and/or method that better protects the concrete supply hose or sections of hose and couplings from excessive wear, lowers the center of gravity of the assembled hose and pan combination, reduces friction between the pan and the support surface, and more reliably secures the hose to the pan or pans, and thus overcomes the shortcomings of the prior art.

These and other objects, advantages, purposes and features of the present invention will become apparent upon review of the following specification in conjunction with the drawings.

### BRIEF DESCRIPTION OF THE DRAWINGS

FIG. 1 is a perspective view of a hose support pan assembly as attached to a concrete supply hose at a wheeled hose moving device in accordance with the present invention;

FIG. 2 is an upper perspective view of the hose support pan assembly of FIG. 1, with a securing element or chain for securing the section of hose at the hose support pan assembly;

FIG. 3 is another upper perspective view of the hose support pan assembly of FIG. 2, with the securing element removed therefrom;

FIG. 4 is a side elevation of the hose support pan assembly of FIG. 3;

FIG. 5 is a top plan view of the hose support pan assembly of FIGS. 3 and 4;

FIG. 6 is an end elevation of the hose support pan assembly of FIGS. 3-5;

FIG. 7 is another upper perspective view of the hose support pan assembly of FIG. 2, with the supply hose removed therefrom;

FIG. 8 is a side elevation of the hose support pan assembly of FIG. 7;

FIG. 9 is a top plan view of the hose support pan assembly of FIGS. 7 and 8; and

FIG. 10 is an end elevation of the hose support pan assembly of FIGS. 7-9.

### DESCRIPTION OF THE PREFERRED EMBODIMENTS

Referring now specifically to the drawings and the illustrative embodiments depicted therein, a hose support pan assembly 10 is configured to receive or retain a section or sections of a concrete supply hose 12 (such as at a coupling 14 joining two adjacent sections of supply hose 12) to provide movable support of the concrete supply hose as the hose is moved over or across a support surface, such as during a concrete placing operation. The pan assembly 10 includes a pan body or body portion 16 and a pair of generally vertically oriented support members 18 extending upwardly from a central region of the pan body 16 and configured to at least partially receive the supply hose section or sections at the upper ends thereof. The pan assembly 10 provides protective support of the supply hose during the placing operation and eases the movement of the hose during the concrete placing operation, as discussed below.

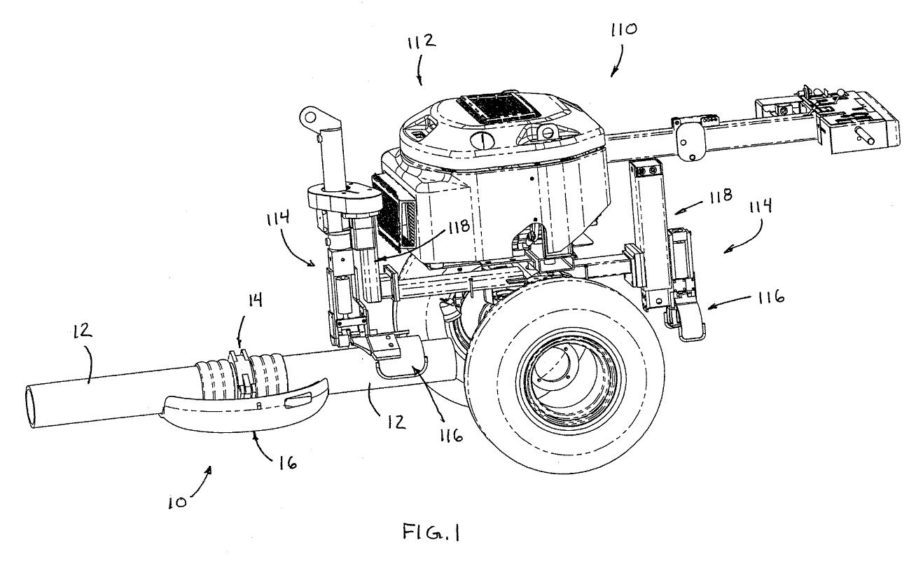

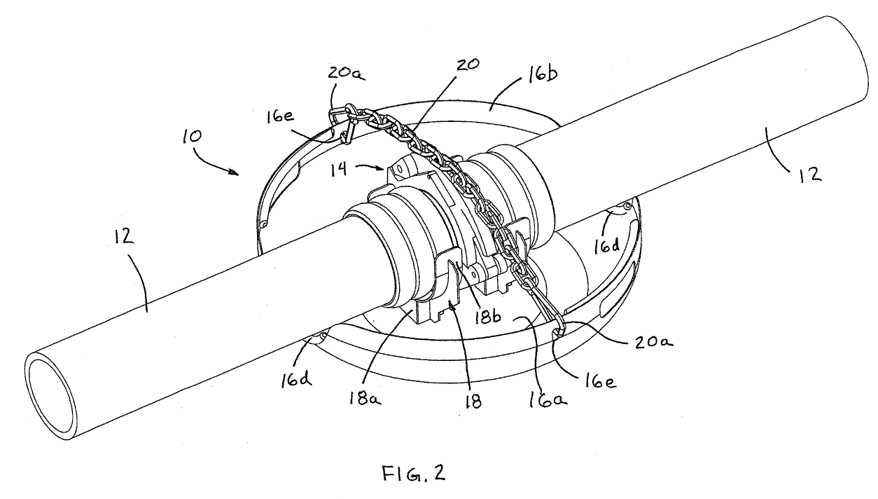

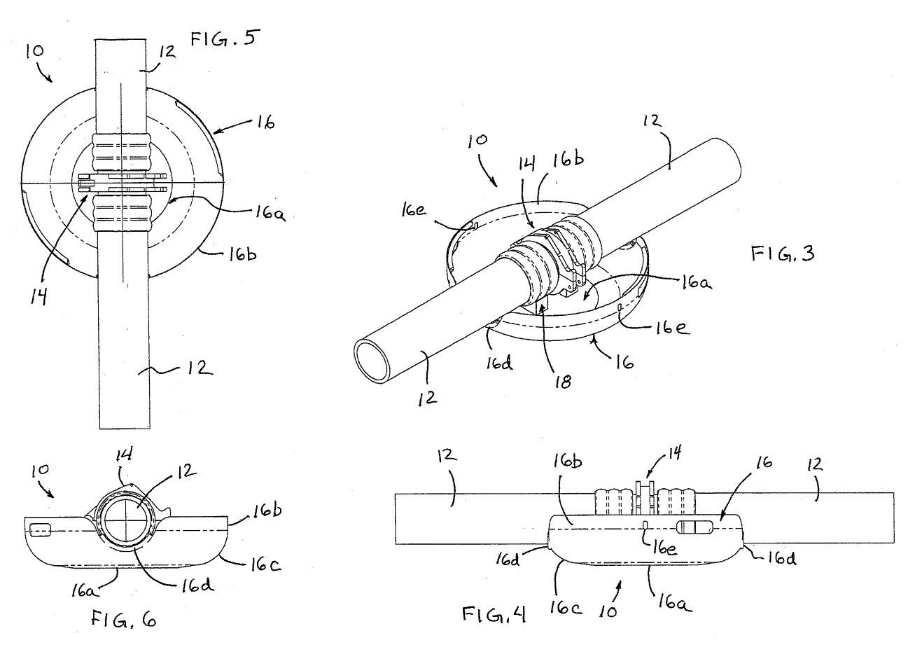

As shown in FIG. 1, the supply hose may be moved over a support surface via a hose moving machine or device 110 that lifts sections of the hose above the support surface to ease the movement and aligning of the hose sections. The non-lifted hose sections may drag along the support surface, whereby the pan assembly 10 eases the movement of the non-lifted hose sections. The hose moving machine may comprise any suitable device or machine, or the movement of the hose may be manually performed or otherwise accomplished without affecting the scope of the present invention.

Optionally, for example, the hose may be moved via a wheeled hose moving device or apparatus or machine 110 that is operable to grasp and move a concrete supply hose or section of hose to move the hose over or along a support surface during a concrete placing operation. The wheeled hose moving device may utilize aspects of the devices described in U.S. patent application Ser. No. 11/585,696, filed Oct. 24, 2006, and published Apr. 26, 2007 as U.S. Pat. Publication No. US-2007-0090203-A1, which is hereby incorporated herein by reference in its entirety. Because the hose moving device is fully described in the above referenced and incorporated patent application, a detailed discussion of the hose moving device need not be included herein. Briefly, the wheeled hose moving device 110 includes a wheeled support or base unit 112 and at least one hose grasping and lifting device or mechanism or apparatus 114 that is movably supported by wheeled support unit 112. Hose grasping and lifting device 114 includes a grasping device 116 (in the illustrated embodiment, wheeled hose moving device 110 includes two grasping devices 116, one at or near each end of the wheeled support unit 112), which is generally vertically movable (such as via an elevation device 118) and is adjustable to engage and grasp a concrete supply hose and to lift or raise or generally vertically move the concrete supply hose. The wheeled support unit 112 may be driven and steered by an operator walking behind the wheeled unit to move the lifted concrete supply hose to a desired or appropriate or targeted location. The hose moving device may utilize aspects of various wheeled devices, such as screeding devices, such as, for example, the Somero Copperhead Laser Screed machine and/or Copperhead XD Laser Screed machine, which are commercially available from Somero Enterprises, Inc. of Houghton, Mich., and such as are described in U.S. Pat. Nos. 6,953,304; 6,976,805; 7,121,762, which are hereby incorporated herein by reference in their entireties, or other wheeled devices, such as the wheeled devices described in U.S. Pat. Nos. 6,588,976 and 6,623,208, which are hereby incorporated herein by reference in their entireties, The concrete supply hose in areas not lifted by the hose moving device may be dragged along and over the support surface, such as the floor or ground or rebar framework or the like, at or near where the concrete is to be placed.

Pan body 16 comprises a generally circular or disk-shaped body with a generally flattened or planar lower surface 16a (at least at a generally central region of the lower surface 16a of pan body 16) and a sidewall 16b that extends generally vertically upward at least partially or circumferentially around the perimeter regions of the lower surface or portion 16a. As can be seen in FIGS. 4, 6, 8 and 10, pan body 16 provides a substantially continuously curved or smooth transition 16c between the generally planar lower surface 16a and the generally vertical sidewall 16b, so that the pan assembly 10 is readily movable over rough or uneven terrain. The generally flattened or planar lower surface 16a provides a large support surface of the pan assembly and thus limits or substantially precludes dipping of the pan into recesses or openings in the support surface, such as openings or gaps or recesses between adjacent rebar sections or members at the concrete placing location.

Pan body 16 also includes a pair of recesses or receiving portions 16d at opposite ends thereof for receiving or partially receiving the concrete supply hose therein. The receiving portions 16d may include a rounded upper edge region and may include a padded edge or protected edge to limit damaging the supply hose when it is received in the receiving portions and supported by the hose support pan assembly 10. The recesses or receiving portions allow the supply hose to be supported at a location or level below the upper edges of the pan sidewalls, and thus the pan assembly provides a lower or reduced profile support of the concrete supply hose at the ground or support surface.

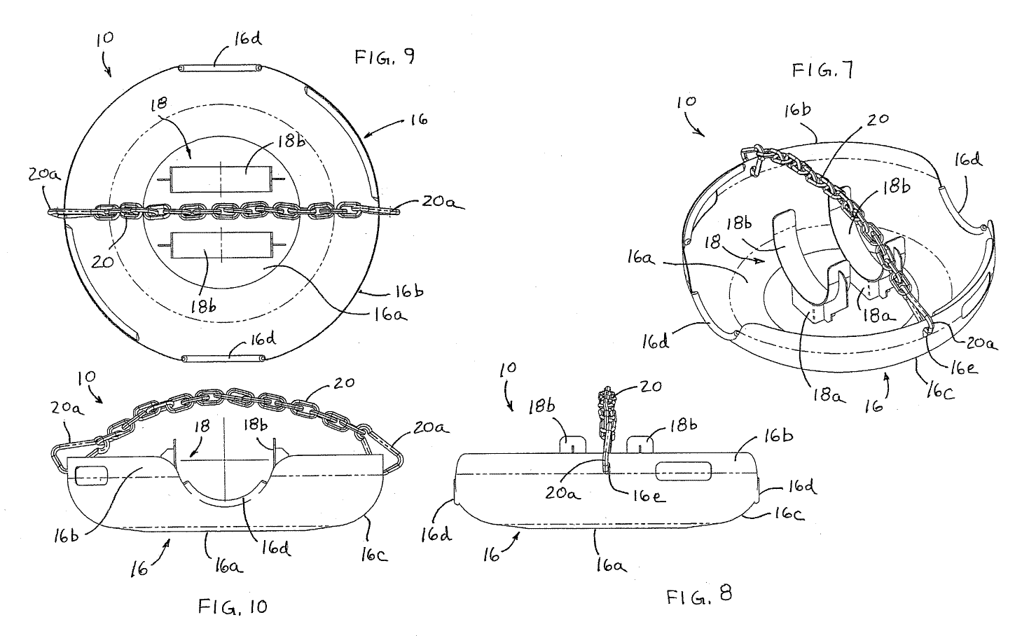

Pan body 16 also includes a pair of apertures 16e at opposite sides or portions of sidewall 16b. Apertures 16e may receive a respective end 20a of a securing element 20 (FIGS. 2 and 7-10), such as a chain or the like, that is attached to pan body 16 at apertures 16e and overlaps the concrete supply hose 12 generally at and/or between the support members 18 to retain or secure the supply hose 12 relative to the hose support pan assembly 10.

Support members 18 comprise a pair of spaced apart support members mounted to pan body 16 at a generally central region thereof and extending generally vertically upward from the lower portion of the pan body 16. Each support member 18 includes a base portion 18a and a curved receiving portion 18b that is curved to correspond generally to the radius of curvature of the supply hose 12 (or coupling 14) that is to be at least partially received in the receiving portions 18b. The receiving portions 18b of support members 18 have support axes (the axis of the pipe or hose received at the receiving portions 18b) that are generally co-axially aligned such that the supported hose is substantially straight between the support members. In the illustrated embodiment, the receiving portions 18b are sized to receive the hose at a coupling 14 between two adjacent or coupled together hose sections to support the hose and to limit flexing or bending of the hose at the coupling. The gap between the receiving portions 18b may be sized to allow portions of the hose coupling to fit between the support members to further limit longitudinal movement of the hose relative to the pan assembly via engagement of the opposed surfaces of the support members by portions of the hose couplings.

As can be seen with reference to FIGS. 4, 6 and 10, the axes of the receiving portions 18b are also substantially co-axially aligned with the axes of the receiving portions 16d of pan body 16, such that the supply hose is substantially uniformly supported in a non-bending or flexing manner across the hose support pan assembly 10. The support member bases 18a and receiving portions 16d of pan body 16 are preferably low profile portions or bases such that the supply hose 12 is supported close to the lower surface or portion 16a of pan body 16. Such a low profile support configuration provides enhanced support of the supply hose and limits or substantially precludes tipping of the hose support pan assembly as it is moved over and across the support surface during the concrete placing operation.

After the supply hose is placed at the receiving portions 16d of pan body and receiving portions 18b of support members 18, the supply hose 12 may be secured relative to the pan body and support members via securing element 20, which, in the illustrated embodiment is a chain. The ends 20a of the chain 20 may be secured to the pan body 16, such as via clipping or securing to the body at the apertures 16e of sidewalls 16b of pan body 16. When so secured, the chain overlays the hose or hose coupling at and generally between the support members 18 to limit or substantially preclude movement of the hose relative to the support members. Optionally, the chain may include an adjustment element, such as a turnbuckle or the like (not shown), to allow for tightening of the chain or securing element at the hose at the support members to substantially secure the hose relative to the pan assembly. By locating the chain over and across a hose coupling, it is envisioned that the chain, when tightened or retained thereat, may provide an anti release function at the coupling to ensure that the coupling remains coupled together at the hose joint by limiting or substantially precluding any radially outward movement of a locking portion of the hose coupling.

Therefore, the present invention provides a pan assembly for supporting a concrete supply hose or hose section or hose sections as the hose is moved over and across a support surface. The hose support pan assembly provides enhanced support of the hose, such as via the low profile support and via the centrally disposed or located support members. The hose support pan assembly also provides for enhanced movement of the hose across or over the support surface via the generally flattened or planar lower surface of the pan body. Such a flattened or generally planar lower surface of the hose support pan assembly limits tipping of the pan assembly and limits dipping of the pan assembly, such as into openings or gaps or spaces between spaced apart rebar members of a rebar grid or the like, such as are used for forming a concrete floor or surface. Also, the curved transition portion between the lower surface and the sidewall of the pan body eases movement of the hose support pan assembly over uneven or rough terrain or surfaces or rebar constructions. Thus, the hose support pan of the present invention better protects the concrete supply hose or sections of hose and couplings from excessive wear as the hose is moved over the support surface or subgrade, lowers the center of gravity of the assembled hose and pan combination, reduces friction between the pan and the support surface or subgrade, and more reliably secures the hose to the pan or pans, as compared to conventional or known support means.

Changes and modifications to the specifically described embodiments may be carried out without departing from the principles of the present invention, which is intended to be limited only by the scope of the appended claims, as interpreted according to the principles of patent law.

1. A pan assembly for supporting a concrete supply hose at a support surface, said pan assembly comprising:
a pan body having a generally planar lower surface and a generally vertical sidewall with a curved transition between said lower surface and said sidewall; and
at least one support member extending upwardly from a generally central region of said pan body and radially inward of said sidewall, said at least one support member being configured to at least partially receive a hose section at an upper end thereof.

2. The pan assembly of claim 1, wherein said at least one support member comprises a pair of spaced apart support members, said support members having receiving axes generally co-axially aligned so as to at least partially receive a hose section at upper ends thereof with the hose section being substantially straight between said support members.

3. The pan assembly of claim 2, wherein said support members are configured to at least partially receive a hose section at a coupling of a hose section.

4. The pan assembly of claim 3 further comprising a securing element that is connectable to said sidewall at opposite portions thereof, said securing element overlaying and engaging the concrete supply hose at the coupling to limit movement of said concrete supply hose relative to said support members.

5. The pan assembly of claim 1 further comprising a securing element that is connectable to said sidewall at opposite portions thereof, said securing element overlaying and engaging the concrete supply hose at or near said at least one support member to limit movement of said concrete supply hose relative to said at least one support member.

6. The pan assembly of claim 5, wherein said securing element comprises a flexible member that is connectable to opposite regions of said sidewall.

7. The pan assembly of claim 1, wherein said sidewall includes hose receiving recesses established at opposite portions thereof, said at least one support member having a hose support axis that is generally aligned with support axes of said hose receiving recesses.

8. The pan assembly of claim 7, wherein said pan assembly provides a low profile support of said concrete supply hose.

9. A pan assembly for supporting a concrete supply hose at a support surface, said pan assembly comprising:
a pan body having a generally planar lower surface and a generally vertical sidewall with a curved transition between said lower surface and said sidewall;
a pair of spaced apart support members extending upwardly from said pan body and radially inward of said sidewall, said support members being configured to at least partially receive a hose section at upper ends thereof, said support members having receiving axes generally co-axially aligned so as to at least partially receive a hose section at upper ends thereof with the hose section being substantially straight between said support members; and
wherein said sidewall includes hose receiving recesses established at opposite portions thereof, said hose receiving recesses being generally aligned with said receiving axes of said support members, and wherein said receiving recesses and said support members support the supply hose at least partially below the upper edge of said sidewall.

10. The pan assembly of claim 9, wherein said pan assembly provides a low profile support of said concrete supply hose.

11. The pan assembly of claim 9, wherein said support members are configured to at least partially receive a hose section at a coupling of a hose section.

12. The pan assembly of claim 11 further comprising a securing element that is connectable to said sidewall at opposite portions thereof, said securing element overlaying and engaging the concrete supply hose at the coupling to limit movement of said concrete supply hose relative to said support members.

13. The pan assembly of claim 9 further comprising a securing element that is connectable to said sidewall at opposite portions thereof, said securing element overlaying and engaging the concrete supply hose at or near or between said support members to limit movement of said concrete supply hose relative to said support members.

14. The pan assembly of claim 13, wherein said securing element comprises a flexible member that is connectable to opposite regions of said sidewall.
